(19) United States
(12) Patent Application Publication
(10) Pub. No.: US 2025/0297653 A1
(43) Pub. Date: Sep. 25, 2025

(54) METHOD OF MANUFACTURING A PISTON FOR A BRAKE ACTUATOR MECHANISM, PISTON AND BRAKE ACTUATOR MECHANISM

(71) Applicant: NTN EUROPE, Annecy (FR)

(72) Inventor: Nicolas THOLLIN, Annecy (FR)

(73) Assignee: NTN EUROPE, Annecy (FR)

(21) Appl. No.: 19/084,918

(22) Filed: Mar. 20, 2025

(30) Foreign Application Priority Data
Mar. 22, 2024 (FR) FR2402914

(51) Int. Cl. F16D 65/16; F16D 125/40

(52) U.S. Cl. CPC F16D 65/16; F16D 2125/40; F16D 2250/0046; F16D 2250/0084

(57) ABSTRACT

A method of manufacturing a piston for a brake actuator mechanism, the piston including a bushing and a nut, the nut including an outer peripheral wall, wherein prior to securing the bushing to the outer peripheral wall of the nut, the bushing is subjected to an abrasion-and corrosion-resistant thermochemical treatment at a temperature Ts until a nitrogen-rich abrasion-and corrosion-resistant surface layer is obtained, and the nut is subjected to a thermochemical hardening treatment including heating to a temperature Tc at least 200° C. higher than Ts, followed by quenching and tempering to a temperature Tr at least 100° C. lower than Ts, and obtaining a carbon-rich hardened surface layer at least locally at the nut thread.

### CROSS-REFERENCE TO RELATED APPLICATIONS

This application claims the benefit of priority under 35 U.S.C. 119 from French Patent Application No. FR2402914, filed Mar. 22, 2024; the disclosure of which is incorporated herein by reference in its entirety.

### FIELD

The invention relates to the field of actuators, particularly for the transport industry, especially automotive or aerospace, especially pistons in mechanisms driven by a worm screw, in particular a ball screw, and more particularly, although not exclusively, brake caliper pistons in braking mechanisms driven by a worm screw, in particular a ball screw.

### BACKGROUND

Document EP 2 787 248 B1 discloses a brake actuator mechanism comprising a screw, a nut and balls positioned between a helical thread on the screw and a helical thread on the nut, the nut forming a piston housed in a guide cylinder. The ball screw mechanism formed by the screw, nut and balls requires sufficient hardness in the screw and nut threads. This type of piston is positioned proximate to the brake caliper and is subject to intense pollution from its direct external environment, which can lead to corrosion of the nut. To protect the ball screw mechanism, the piston and its guide cylinder must be kept with a low degree of constructive clearance, which generates the risk of abrasion, accentuated by the presence of pollutants. The risks of mechanism failure are therefore numerous.

Document EP 2 304 265 B1 discloses a brake actuator mechanism comprising a piston sliding in a cylinder and driven by a ball screw mechanism. The piston is made in several parts, and integrates the nut of the ball screw mechanism, a solid pressure piece in which the nut is shrunk, and an outer piece shrunk onto the pressure piece, the outer piece having a bottom on which a frustoconical surface of the pressure piece rests. The purpose of this three-piece piston design is to pool some of the piston parts in several different-sized models, with the intermediate pressure piece acting as a kind of adapter.

### SUMMARY

The aim of the invention is to overcome the disadvantages of the prior art and to offer a piston that is more resistant to abrasion and corrosion and is economically advantageous, while remaining compact.

To this end, according to a first aspect of the invention, a method is proposed for manufacturing a piston of a brake actuator mechanism, the piston comprising a nut of a ball screw mechanism, defining a reference axis, an outer peripheral wall and a nut thread intended to form a raceway for balls of the ball screw mechanism; a bushing secured to the nut and at least partially covering the outer peripheral wall of the nut, the bushing being intended to come into fitted sliding contact with an inner guide wall of a guide cylinder of the brake actuator mechanism; remarkable in that, prior to securing the bushing to the outer peripheral wall of the nut, the bushing is subjected to an abrasion-and corrosion-resistant thermochemical treatment at a temperature Ts until a nitrogen-rich abrasion-and corrosion-resistant surface layer is obtained, and the nut is subjected to a thermochemical hardening treatment including heating to a temperature Tc at least 200° C. higher than Ts, followed by quenching and tempering at a temperature Tr at least 100° C. lower than Ts, and obtaining a carbon-rich hardened zone at least locally at the nut thread.

Thermochemical treatment for abrasion and corrosion resistance and thermochemical treatment for hardening confer distinct advantages on the same material. However, the methods used to apply each of the two treatments differ and, regardless of the order in which they are applied to the same part, the properties imparted by one treatment cancel out those imparted by the other. More specifically, assuming that we start treating a part to increase its hardening by a thermochemical treatment with carbon enrichment involving quenching and tempering at the end of the treatment at a tempering temperature Tr, the subsequent treatment of another portion of the same part at a temperature Ts substantially higher than the tempering temperature Tr will remove the effects of the quenching and tempering, releasing the carbon compounds and eliminating the hardening effect sought with the initial hardening treatment. Conversely, if an initial thermochemical abrasion-resistance treatment is carried out on a part at a temperature Ts involving nitrogen enrichment of a surface zone of the part, a subsequent hardening treatment of another portion of the same part at a temperature Tc substantially higher than Ts results in the release of the nitrogen compounds retained on the surface of the material during the initial treatment. It is therefore not possible to have a single-piece part with the desired properties provided by both treatments, in an economically viable way. By carrying out these two treatments on a separate part, that is, the bushing and the nut, which are to be assembled, it is possible to offer a composite piston with all the desired properties.

The nut is preferably made of steel, for example 20MnCr5, 23MnB4, Scr420, 16MnCr5 or their equivalents according to other international or national standards, or high-carbon steel such as 100Cr6, C50 or C56 or their equivalents. The thermochemical hardening treatment is preferably carried out in a gaseous medium. The quenching and tempering stages enable a high surface hardness to be achieved, for example a hardness in excess of 58 HRC (Rockwell hardness), while retaining a high level of toughness in the core of the part. This treatment increases the hardness of the nut thread, making it more durable and resistant to chipping, for example. The thermochemical hardening treatment can be a surface treatment, but is preferably a deep treatment to a thickness exceeding 0.5 mm, and preferably exceeding 2 mm. It can also be a core treatment.

According to one embodiment, the thermochemical hardening treatment includes a carburizing treatment, with temperature Tc above 900° C. and temperature Tr below 250° C. Alternatively, it can be a carbonitriding treatment.

The bushing is preferably made of steel, or of a material substantially containing steel. According to one embodiment, the abrasion-and corrosion-resistant treatment includes nitriding or nitrocarburizing, with the temperature Ts ranging from 300° C. to 580° C. Owing to this treatment, the piston is resistant to abrasion and corrosion, which can be initiated by its translational movements and particulate pollution in the guide cylinder.

According to one embodiment, an outer face of the bushing is ground before being subjected to the abrasion-and corrosion-resistant thermochemical treatment, so that the outer surface of the bushing is perfectly smooth, thereby reducing piston friction in the guide cylinder and thus improving efficiency, as well as increasing abrasion-and corrosion-resistance.

According to one embodiment, after completion of the thermochemical abrasion and corrosion resistance treatment and the thermochemical hardening treatment, the bushing is secured, preferably by shrinking, to the outer peripheral wall of the nut. In this way, initially incompatible properties are brought together in a single set of parts. This makes the piston harder at the nut thread and more resistant at its contact surface with the guide cylinder. Owing to its relatively low thickness, the bushing provides an additional property to the piston without considerably increasing the volume of the brake actuator mechanism.

According to one embodiment, an outer surface of a bottom wall of the nut or bushing undergoes an additional anti-corrosion treatment, preferably the additional anti-corrosion treatment is a zinc flake coating treatment, this bottom wall being intended to come into direct or indirect abutment against the brake caliper.

According to one embodiment, a piston slider undergoes a surface treatment before being partially inserted into a housing formed in the nut and bushing; preferably, the surface treatment of the slider is nitrocarburizing. The slider may contribute to the cohesion between the nut and the bushing, but its main function is to ensure, in cooperation with a straight groove formed in the guide cylinder of the brake actuator mechanism, non-rotational translational guidance of the piston in the cylinder. Owing to its additional treatment, the slider is resistant to abrasion and corrosion, enabling the brake actuator mechanism to last longer.

According to another aspect of the invention, it relates to a piston remarkable in that it is manufactured according to the manufacturing method as described above. This piston is characterized in particular by a nitrogen-rich surface metallurgy at the bushing, resulting from the thermochemical abrasion-resistance treatment, and by a carbon-rich metallurgy conferring high hardness at least at the nut thread.

According to one embodiment, the nut has an open external recirculation channel, closed at least in part by the bushing. This feature facilitates machining of the recirculation channel and, if required, assembly and introduction of the balls into the mechanism.

According to one embodiment, the bushing has a bottom. In this configuration, the bottom of the bushing can, if required, bear alone against the brake caliper, and the nut can be open at both axial ends.

According to one embodiment, the bushing has a fold of material on an annular end face of the nut, which ensures axial positioning between the sleeve and the nut.

According to one embodiment, the piston comprises an axially outwardly projecting slide for securing the piston in rotation in the guide cylinder, while allowing it to move in translation.

The piston described is intended in particular for vehicle brake actuators.

According to another aspect of the invention, it relates to a brake actuator mechanism, comprising a guide cylinder defining a reference axis of the brake actuator mechanism; a ball screw mechanism, comprising a screw and a nut centered on the reference axis, and balls, the screw having at least one screw thread forming a raceway for the balls, the nut having a nut thread forming a raceway for the balls and an outer peripheral wall; and a bushing secured to the nut and at least partially covering the outer peripheral wall of the nut, the bushing coming into tight sliding contact with an inner guide wall of the guide cylinder; remarkable in that the bushing and the nut constitute a piston as described above.

### BRIEF DESCRIPTION OF THE DRAWINGS

Other features and advantages of the invention will emerge on reading the following disclosure, with reference to the appended figures.

FIG. 1 shows a brake actuating mechanism according to one embodiment comprising an internally recirculating piston with a closed nut.

FIG. 2 shows a brake actuating mechanism according to one embodiment comprising an externally recirculating piston with a closed nut.

FIG. 3 shows a brake actuating mechanism according to one embodiment comprising a piston with an open nut.

For greater clarity, identical or similar elements are identified by identical reference signs in all of the Figures.

### DETAILED DESCRIPTION

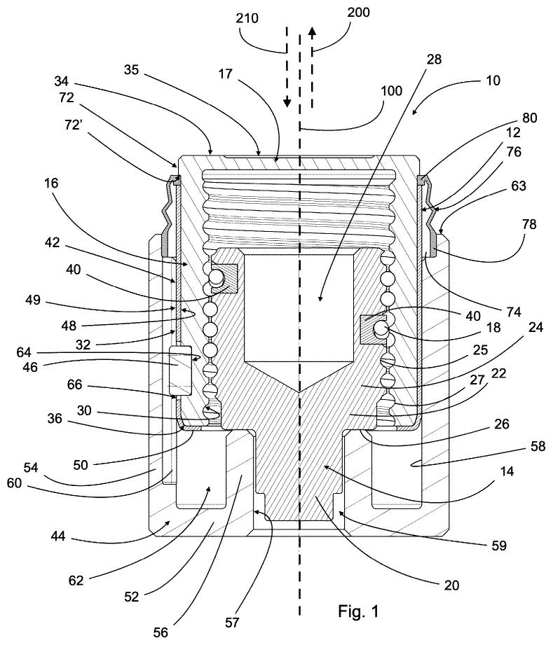

FIG. 1 shows a first embodiment of a brake actuator mechanism 10 comprising a fixed guide cylinder 44 defining a reference axis 100 of the brake actuator mechanism 10 and a piston 12 sliding in translation in the guide cylinder 44 along the reference axis 100, which is also a reference axis of the piston, to bear directly or indirectly against a brake caliper (not shown). The piston 12 comprises a bushing 42 and a nut 16, the nut 16 being part of a ball screw mechanism comprising two threaded components, namely a screw 14 and the nut 16, and balls 18.

The screw 14 is preferably metallic, for example steel such as 20MnCr5, 23MnB4, Scr420, 16MnCr5 or their equivalents according to other international or national standards, or high-carbon steel such as 100Cr6, C50 or C56 or their equivalents, and may comprise a screw head 20, a connecting portion 22 and a screw body 24. The screw body 24 has a larger diameter than the screw head 20, with the connecting portion 22 providing the connection between the screw body 24 and the screw head 20. This connecting portion 22 may be frustoconical, preferably cylindrical, and forms a first flat shoulder 26. The screw head 20 is designed to be rotationally attached to the output shaft of an electric motor or gearmotor, and may have a non-circular interface, for example with four, six or eight hexagons.

The screw body 24 has a screw thread 25 which forms an inner helical raceway about the reference axis 100 of the ball screw mechanism, the inner helical raceway facing radially away from the reference axis 100. Additionally, the screw 14 has an open central cavity 28 to lighten the overall weight of the brake actuator mechanism 10, and to provide a receptacle for grease contained in the ball screw mechanism.

The nut 16 is made of steel, for example 20MnCr5, 23MnB4, Scr420, 16MnCr5 or their equivalents according to other international or national standards, or high-carbon steel such as 100Cr6, C50 or C56 or their equivalents. The nut 16 is cylindrical overall, with the reference axis 100 as its central axis. The nut 16 has a nut thread 27 which forms an outer helical raceway about the reference axis 100 and facing radially toward the reference axis 100. The nut 16 has a cylindrical outer peripheral face 32 in which a locking mortise 64 is formed.

In addition, the nut 16 is of the closed type in the sense that it has a bottom 17, with an outer closure face 34 which may have a recess 35, and is configured to make direct or indirect contact with a brake caliper (not shown in the figures). The outer closure face 34 further has a flange 72, projecting radially from the outer peripheral wall 32, which forms a flange shoulder 72′. The flange 72 further limits any deformation of the outer closure face 34 under mechanical stress when the brake actuator mechanism 10 is activated, for example.

One of the two threaded components, that is, the screw 14 or nut 16, may further be equipped with means 40 for recirculating the balls 18, which may comprise one or more recirculators each passing through a thread of the threaded component, as shown in FIG. 1, or pairs of recirculators arranged at the ends of a recirculation channel that spans one or more turns of the raceways of the screw 14 and nut 16. The system could also operate on a non-recirculating system.

The balls 18 can be made of steel or ceramic, for example, and are sized and positioned to circulate in a closed circuit between the outer helical raceway of the nut 16 and the inner helical raceway of the screw 14, as well as, if need be, by the recirculation means 40, preferably without separators between the balls 18.

The bushing 42 is metallic, for example made of steel, for example 20MnCr5, 23MnB4, Scr420, 16MnCr5 or their equivalents according to other international or national standards, or high-carbon steel such as 100Cr6, C50 or C56 or their equivalents. The bushing 42 has a cylindrical inner face 48 shrunk onto at least part of the outer peripheral wall 32 of the nut 16. The bushing 42 has a bushing outer face 49, and a thickness between the cylindrical inner face 48 and the bushing outer face 49 is of the order of 1 mm. The bushing 42 has a locking slot 66, such as a through hole, generally rectangular, located proximate to the annular end face 36 of the nut 16. The locking slot 66 gives access to the locking mortise 64 of the nut 16. Additionally, the bushing 42 can feature a bushing shoulder 50 which rests axially on the annular end face 36 of the nut 16, opposite the bottom 17 of the nut.

The brake actuator mechanism 10 also comprises a slider 46, shrunk into the locking mortise 64, projecting radially toward the guide cylinder 44 through the locking slot 66, relative to the outer face of the bushing 49.

The guide cylinder 44 is made of a metal base, for example steel, and comprises a preferably flat annular base 52, a guide body 54 projecting axially from the outer periphery of the annular base 52, and an inner sealing skirt 56 projecting axially from the inner periphery of the annular base 52.

The guide body 54 is a cylinder whose central axis is the reference axis 100. The guide body 54 comprises an inner guide wall 58, facing radially toward the reference axis 100, in sliding contact with the bushing 42.

The inner sealing skirt 56 has a cylindrical inner face 57, facing radially toward the reference axis 100, delimiting an intermediate space 59. The inner guide surface 57 is positioned opposite and at a short distance from the screw shaft 20, to form a dynamic, non-contact seal in this area, to keep the lubricating grease in the guide cylinder 44.

The annular base 52, the guide body 54 and the inner guide skirt 56 delimit an annular space 62.

The guide body 54 has an open annular end 63 comprising a chamfer 74. The guide body 54 comprises longitudinal axial locking groove 60, extending from the open annular end 63 toward the annular base 52, over a predetermined distance, for example 9/10 of the height of the inner guide wall 58. The locking groove 60 is configured to receive the slider 46 in sliding contact, in order to lock the piston 12 in rotation with respect to the guide cylinder 44, while allowing it translational movement in the guide cylinder 44.

The brake actuator mechanism 10 further features an annular bellows 76, comprising an annular bellows base 78 configured to fit into the chamfer 74, and a bellows head 80 configured to be pinched between the flange shoulder 72′ of the flange 72, and the bushing 42, radially abutting the outer peripheral wall 32. This annular bellows 76 prevents the ingress of contaminants into the guide cylinder 44 by providing a primary seal. The annular bellows 76 is optional, and so may not be integrated into the brake actuator mechanism 10 if the latter is intended to operate in an unpolluted environment.

When the piston 12 of the brake actuator mechanism 10 is assembled, the nut 16 is forcibly inserted into the bushing 42, in an axial assembly direction 210, until the annular end face 36 of the nut 16 abuts the bushing shoulder 50, or until an axial position is reached which ensures that the annular bellows 76 is held in position. The bushing 42 is shrunk onto the nut 16 to form a one-piece assembly. The assembly is carried out with angular indexing so that the locking mortise 64 of the nut 16 and the locking slot 66 of the bushing 42 are located opposite one another, and the locking slot 66 allows access to the locking mortise 64.

The slider 46 is then inserted into the locking mortise 64 of the nut 16 through the locking slot 66.

The screw 14 is then inserted into the nut 16 of the piston 12, using a progressive helical movement to insert the balls 18 one by one.

The sub-assembly consisting of the screw 14 and piston 12 fitted with the slider 46 is then inserted into the guide cylinder 44 in the axial assembly direction 210. To do this, the locking slot 66 of the bushing 42 and the locking mortise 64 of the nut 16 must be inserted opposite the locking groove 60 of the guide body 54 of the locking cylinder 44, while the slider 46 enters the locking groove 60. The outer face of the bushing 49 then comes into sliding contact with the inner guide wall 58 of the guide body 54.

The slider 46 inserted in the locking groove 60 has only one degree of freedom, within the functional clearances, in translation parallel to the reference axis 100 in the locking groove 60. The slider 46 then locks the piston 12 in rotation about the reference axis 100, while allowing it a degree of translational freedom parallel to the reference axis 100.

When the piston 12, bushing 42 and slider 46 are inserted into the guide cylinder 44 and reach their usage position, the first flat shoulder 26 of the connecting portion 22 of the screw 14 abuts the inner guide skirt 56, while the screw shaft 20 is housed in the intermediate space 59.

Finally, the annular bellows 76 can be fitted to provide a primary seal for the brake actuator 10.

In operation, a rotational movement of the screw 14 about the reference axis 100, driven in rotation at the screw head 20 by a motor, generates a translational movement of the piston 12 in a direction which is based on the direction of rotation of the screw 14.

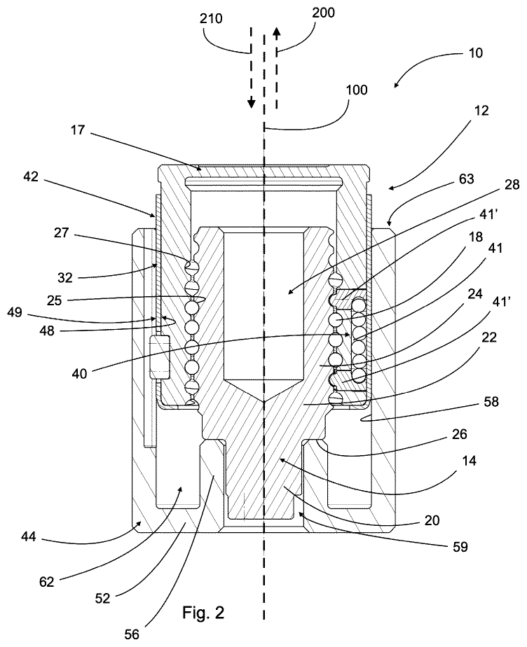

According to another embodiment, shown in FIG. 2, the brake actuator mechanism 10 differs from that described in the first embodiment in that the brake actuator mechanism 10 has no annular bellows 76 and no chamfer 74. Additionally, the recirculation means 40 are formed at the nut 16, which has an external recirculation channel 41 and recirculators 41′, enabling external recirculation of the balls 18. Here, the recirculation channel 41 is open, and closed again when the brake actuator mechanism 10 is assembled by the cylindrical inner face 48 of the bushing 42. In the absence of a bellows, sealing is achieved at this point by sliding contact between the bushing 42 and the inner guide wall 58 of the guide body 54.

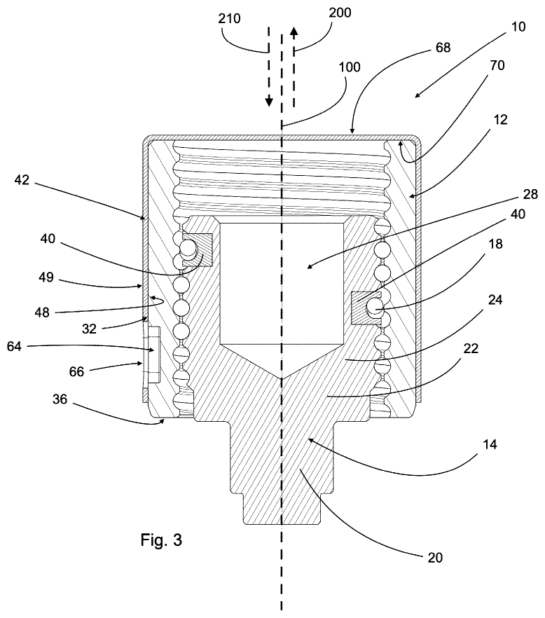

According to a third embodiment shown in FIG. 3, the brake actuator mechanism 10 differs from that described in the first embodiment in that the brake actuator mechanism 10 has neither an annular bellows 76 nor a chamfer 74. Additionally, the nut 16 is of the open type, and has no outer closure face 34. In addition, the bushing 42 does not have the bushing shoulder 50 which rests axially in the axial direction 200 opposite the assembly direction 210 on the annular end face 36 of the nut 16.

The bushing 42 then has a closed bottom 68, preferably flat, which comes to rest against an annular upper end surface of the nut 70. The closed bushing bottom 68 then presses directly or indirectly against the brake pad when the brake actuator mechanism 10 is actuated. Conversely, when the brake actuator mechanism 10 is not actuated, and therefore the piston 12 is in the free position, it is the annular end face 36 of the nut 16 that abuts against the base 52.

In all the embodiments described above, the bushing 42 undergoes thermochemical treatment to resist abrasion and corrosion at a temperature Ts until a nitrogen-rich abrasion-and corrosion-resistant surface layer is obtained, prior to assembly on the nut 16. The treatment to obtain such a layer includes nitriding or nitrocarburizing, with the temperature Ts ranging from 300° C. to 580° C. Nitriding and/or nitrocarburizing enable nitride to form on the surface when a part is placed in a very nitrogen-rich treatment atmosphere at temperature Ts, allowing a different material to form on the surface. Owing to this treatment, the outer face 49 of the bushing 42 of the piston 12 is resistant to abrasion and corrosion that could occur under operating conditions, when the piston 12 slides in translation in the guide cylinder 44. Since nitrocarburizing does not alter the flatness of a surface, it is possible to grind the outer face 49 of the bushing 42 before applying the thermochemical treatment.

Similarly, the nut 16 is subjected to a thermochemical hardening treatment including heating to a temperature Tc at least 200° C. higher than Ts, preferably at least 900° C. higher. The thermochemical hardening treatment, for example of the surface or core carburizing type, then includes quenching and tempering at a temperature Tr at least 100° C. below Ts, preferably below 200° C. This treatment produces a hardened, carbon-rich surface layer at least locally on the nut thread 27 of the inner surface of the nut 30. Owing to this treatment, the nut thread 27 has increased surface and depth hardness, making it more durable by resisting chipping, for example. However, carburizing modifies the flatness of a workpiece surface, so it is necessary to carry out a grinding, hard turning or hard milling step on the inner surface of the nut 30 after the thermochemical treatment has been applied.

In the first two embodiments, the part in contact with the brake caliper or its actuating mechanism, that is, the outer closure face 34, is preferably given an additional surface coating. This additional treatment is, for example, an application of zinc flake on the surface or another surface treatment method. This additional treatment makes the outer closure face 34 more resistant to pressure when the brake actuator mechanism 10 is actuated. In the third embodiment, this additional treatment is not necessary, due to the anti-corrosion properties provided by the thermochemical treatment of the bushing.

The thermochemical hardening treatment (carburizing/quenching/tempering) involves the introduction of carbon into at least one surface layer of a steel material, followed by its fixation by quenching and tempering. The aim is to increase the carbon content at least near the surface to give the part the desired hardness.

The thermochemical treatment to resist abrasion and corrosion (nitriding/nitrocarburizing) involves introducing nitrogen into the material's surface layer. It can produce highly wear-resistant surface layers, particularly when nitrides, such as iron nitride (Fe₃N) or chromium nitride (Cr₂N), form on the surface.

If the thermochemical treatment for abrasion and corrosion resistance is carried out after assembly of the bushing 42 on the nut 16 and after the thermochemical treatment for hardening the nut 16, it is not possible to thermally isolate the nut, so that the nut thread 27 is brought to a temperature close to Ts, sufficient to annihilate the carbon bonding effect obtained by quenching and tempering. Conversely, if the thermochemical hardening treatment is carried out after assembly of the bushing 42 on the nut 16 and after the thermochemical abrasion and corrosion resistance treatment, it is not possible to thermally isolate the bushing 42, so it is brought to a temperature close to Tc, well above Ts, which releases the nitrogen compounds attached to the surface of the sleeve 42 by the thermochemical abrasion and corrosion resistance treatment. For this reason, these two incompatible treatments are carried out on the two parts—nut 16 and bushing 42—before they are assembled.

Naturally, the examples shown in the figures and discussed above are provided for illustrative and non-limiting purposes only. It is explicitly provided that it is possible to combine the various illustrated embodiments in order to provide others.

In a variant not shown, the external recirculation channel 41 is located in the screw 14.

In another variant, the bushing 42 and/or the guide cylinder 44 are each composed of a metal base treated according to the thermochemical treatment described above, and of resin comprising the desired properties in order to reduce friction between the bushing 42 and the guide cylinder 44, the resin being able to form the bushing 42 and/or the guide cylinder 44 by molding or 3D printing, for example.

1. A method of manufacturing a piston of a brake actuator mechanism, comprising:
providing a nut for a ball screw mechanism, defining a reference axis, an outer peripheral wall and a nut thread for forming a raceway for balls of the ball screw mechanism;
securing a bushing to the nut such that the bushing at least partially covers the outer peripheral wall of the nut, the bushing being intended to come into tight sliding contact with an inner guide wall of a guide cylinder of the brake actuator mechanism; and
prior to securing the bushing to the outer peripheral wall of the nut, subjecting the bushing to a thermochemical abrasion and corrosion resistance treatment at a temperature Ts until a nitrogen-rich abrasion-and corrosion-resistant surface layer is obtained, and subjecting the nut to a thermochemical hardening treatment including heating to a temperature Tc at least 200° C. higher than a temperature Ts, followed by quenching and tempering to a temperature Tr at least 100° C. lower than Ts, and obtaining a carbon-rich hardened zone at least locally at the nut thread.

2. The method of claim 1, wherein the thermochemical hardening treatment includes a carburizing treatment, the temperature Tc being greater than 900° C., the temperature Tr being less than 250° C.

3. The method of claim 1, wherein the thermochemical abrasion and corrosion resistance treatment includes nitriding or nitrocarburizing, the temperature Ts being between 300° C. and 580° C.

4. The method of claim 1, wherein an outer face of the bushing is ground before being subjected to the thermochemical abrasion and corrosion resistance treatment.

5. The method of claim 1, wherein, after completion of the thermochemical abrasion and corrosion resistance treatment and the thermochemical hardening treatment, the bushing is secured to the outer peripheral wall of the nut.

6. The method of claim 1, wherein an outer surface of a bottom wall of the nut or bushing undergoes an additional anti-corrosion treatment.

7. The method of claim 6, wherein the additional anticorrosion treatment is a zinc flake coating treatment.

8. The method of claim 1, wherein a slider of the piston undergoes a surface treatment before being partially inserted into a housing formed in the nut and the bushing.

9. The method of claim 8, wherein the surface treatment of the slider is nitrocarburizing.

10. A piston manufactured according to the method of claim 1.

11. The piston of claim 10, wherein the nut has an open external recirculation channel, closed at least in part by the bushing.

12. The piston of claim 10, wherein the bushing has a bottom.

13. The piston of claim 10, wherein the bushing has a material fold on an annular end face of the nut.

14. The piston of claim 10, comprising an axially outwardly projecting slider.

15. A brake actuator mechanism, comprising:
a guide cylinder defining a reference axis of the brake actuator mechanism;
a ball screw mechanism, comprising a screw and a nut centered on the reference axis, and balls, the screw having at least one screw thread forming a raceway for the balls, the nut having a nut thread forming a raceway for the balls and an outer peripheral wall; and
a bushing secured to the nut and at least partially covering the outer peripheral wall of the nut, the bushing coming into tight sliding contact with an inner guide wall of the guide cylinder;
wherein the bushing and the nut constitute a piston manufactured according to the method of claim 1.

16. The brake actuator mechanism of claim 15, wherein the nut has an open external recirculation channel, closed at least in part by the bushing.

17. The brake actuator mechanism of claim 15, wherein the bushing has a bottom.

18. The brake actuator mechanism of claim 15, wherein the bushing has a material fold on an annular end face of the nut.

19. The brake actuator mechanism of claim 15, wherein the piston comprises an axially outwardly projecting slider.

20. The method of claim 1, wherein, after completion of the thermochemical abrasion and corrosion resistance treatment and the thermochemical hardening treatment, the bushing is secured by shrinking to the outer peripheral wall of the nut.
